(19) United States
(12) Patent Application Publication
(10) Pub. No.: US 2024/0290996 A1
(43) Pub. Date: Aug. 29, 2024

(54) CONTROL SYSTEM FOR FLOW CONTROL VALVE

(71) Applicants: Hyundai Motor Company, Seoul (KR); Kia Corporation, Seoul (KR)

(72) Inventors: Wook Il JANG, Yongin-Si (KR); Chul Wan PARK, Yongin-Si (KR); Soo Hwan KIM, Yongin-Si (KR); Kyeong Jun BAEK, Seongnam-Si (KR); Tae Geun KIM, Seoul (KR); Sun Ae PARK, Seongnam-Si (KR)

(73) Assignees: Hyundai Motor Company, Seoul (KR); Kia Corporation, Seoul (KR)

(21) Appl. No.: 18/210,904

(22) Filed: Jun. 16, 2023

(30) Foreign Application Priority Data
Feb. 27, 2023 (KR) 10-2023-0025685

(51) Int. Cl. H01M 8/04029; F16K 11/087; H01M 8/0432; H01M 8/04701; H01M 8/04746

(52) U.S. Cl. CPC H01M 8/04029; F16K 11/0873; H01M 8/04358; H01M 8/04723; H01M 8/04768; H01M 2250/20

(57) ABSTRACT

A control system includes a flow control valve for control of a coolant flow path and a controller configured for control of an opening amount of the flow control valve. The flow control valve includes ports respectively communicating with a fuel cell stack, a radiator, a coolant pump, and an ion filter. The controller is configured to control the flow control valve to open a first port connected to the ion filter within a predetermined section in a temperature control section of a fuel cell thermal management system. The temperature control section is a section between a point where the second port connected to the radiator is completely closed and the third port connected to the fuel cell stack is completely opened and a point where the second port connected to the radiator is completely opened and the third port connected to the fuel cell stack is completely closed.

### CROSS-REFERENCE TO RELATED APPLICATION

The present application claims priority to Korean Patent Application No. 10-2023-0025685, filed on Feb. 27, 2023, the entire contents of which is incorporated herein for all purposes by this reference.

### BACKGROUND OF THE PRESENT DISCLOSURE

### Field of the Present Disclosure

The present disclosure relates to a control system for a flow control valve configured to implement an opening strategy of the flow control valve configured for improving durability of an ion filter.

### DESCRIPTION OF RELATED ART

Generally, a fuel cell system applied to a hydrogen fuel cell vehicle includes a fuel cell stack configured to generate electrical energy from an electrochemical reaction of reaction gas, a hydrogen supply device configured to supply hydrogen serving as a fuel to the fuel cell stack, an air supply device configured to supply air containing oxygen, which is an oxidant required for the electrochemical reaction, to the fuel cell stack, and a thermal management system (TMS) configured to optimally control the operation temperature of the fuel cell stack and to perform a water management function by releasing heat, which is a by-product generated by the electrochemical reaction of the fuel cell stack, to the outside.

Because a fuel cell thermal management system includes a pump, a COD heater, an ion filter, a valve, a controller, and the like in the modular state, it is possible to implement a cooling loop, a heating loop, an ion filter loop, or the like configured to circulate a coolant differently depending on the state of a fuel cell vehicle.

The ion filter applied to the fuel cell thermal management system is a component configured to remove ions present in a coolant. Because the ion filter is a consumable, the same is required to be regularly replaced according to the mileage of a vehicle. Accordingly, it is important to secure durability of the ion filter. However, when a large amount of coolant flows into the ion filter in the cooling loop of the fuel cell thermal management system configured to cool the coolant, durability of the ion filter deteriorates. Furthermore, when the coolant does not flow into the ion filter in the cooling loop of the fuel cell thermal management system, conductivity of the coolant increases. Therefore, it is required to control a flow path of a coolant to secure durability of an ion filter and prevent an increase in conductivity of the coolant.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a control system for a flow control valve configured to implement an opening strategy of the flow control valve configured for securing durability of an ion filter and preventing an increase in conductivity of a coolant.

In one aspect, the present disclosure provides a control system for a flow control valve, the control system including the flow control valve configured to control a flow path of a coolant and a controller configure to control an opening amount of the flow control valve, wherein the flow control valve includes ports fluidically-communicating with a fuel cell stack, a radiator, a coolant pump, and an ion filter, respectively, wherein the ports include a first port, a second port and a third port, and the controller is configured to control the flow control valve so that the first port of the flow control valve, the first port being connected to the ion filter, is opened only within a predetermined section in a temperature control section of a fuel cell thermal management system, and wherein the temperature control section is a section between a point at which the second port connected to the radiator is completely closed and the third port connected to the fuel cell stack is completely opened and a point at which the second port connected to the radiator is completely opened and the third port connected to the fuel cell stack is completely closed.

In an exemplary embodiment of the present disclosure, an opening amount of the second port of the flow control valve, the second port being connected to the radiator, may increase as an opening angle of the flow control valve increases in the temperature control section.

In another exemplary embodiment of the present disclosure, a closing amount of the third port of the flow control valve, the third port being connected to the fuel cell stack, may increase as the opening angle of the flow control valve increases in the temperature control section.

In yet another exemplary embodiment of the present disclosure, the first port may be partially opened within an opening angle range of the flow control valve, wherein an opening amount of the third port is greater than an opening amount of the second port in the opening angle range.

In yet another exemplary embodiment of the present disclosure, a port of the flow control valve connected to the ion filter may be partially opened in the temperature control section.

In still yet another exemplary embodiment of the present disclosure, in the temperature control section, a flow rate of the coolant flowing into the flow control valve by opening the first port of the flow control valve connected to the ion filter may be less than 50% of a maximum flow rate of the coolant flowing from the radiator into the flow control valve.

In a further exemplary embodiment of the present disclosure, the flow control valve may be a four-way valve or a five-way valve.

In another further exemplary embodiment of the present disclosure, the flow control valve may include a housing including the ports configured respectively fluidically-communicating with the fuel cell stack, the radiator, the coolant pump, and the ion filter and a valve structure disposed in the housing and rotated to fluidically-communicate with a part of the ports, and the valve structure may be formed of a plurality of stages.

In yet another further exemplary embodiment of the present disclosure, the valve structure may include one stage configured to fluidically-communicate with the ion filter, and the one stage may include, when the flow control valve is a five-way valve, a first opening and a second opening opened for a flow of the coolant.

In yet another further exemplary embodiment of the present disclosure, the first opening and the second opening may be spaced from each other, and an opening area of the first opening may be greater than an opening area of the second opening.

In still yet another further exemplary embodiment of the present disclosure, the first port of the flow control valve connected to the ion filter may be configured to fluidically-communicate with the second opening in the temperature control section.

In a still further exemplary embodiment of the present disclosure, the valve structure may include a first stage configured to fluidically-communicate with the radiator and the coolant pump, a second stage configured to fluidically-communicate with the ion filter, and a third stage configured to fluidically-communicate with the fuel cell stack and a COD heater.

In a yet still further exemplary embodiment of the present disclosure, the valve structure may include one stage configured to fluidically-communicate with the ion filter, and the one stage may include, when the flow control valve is a four-way valve, one opening opened for a flow of the coolant.

In a yet exemplary embodiment of the present disclosure, the first port of the flow control valve connected to the ion filter may be configured to fluidically-communicate with the one opening in the temperature control section, and the first port may be partially opened by the one opening.

In a yet further exemplary embodiment of the present disclosure, the valve structure may include a first stage configured to fluidically-communicate with the radiator and the coolant pump and a second stage configured to fluidically-communicate with the ion filter.

Other aspects and exemplary embodiments of the present disclosure are discussed infra.

It is understood that the terms “vehicle”, “vehicular”, and other similar terms as used herein are inclusive of motor vehicles in general, such as passenger automobiles including sports utility vehicles (SUV), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

The above and other features of the present disclosure are discussed infra.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a diagram illustrating a fuel cell thermal management system according to an exemplary embodiment of the present disclosure;

FIG. 2 is a diagram illustrating a flow control valve in FIG. 1;

FIG. 3 is a diagram illustrating an opening strategy of the flow control valve according to the exemplary embodiment of the present disclosure;

FIG. 4 is a diagram illustrating a valve structure according to the exemplary embodiment of the present disclosure;

FIG. 5 is a diagram illustrating a fuel cell thermal management system according to another exemplary embodiment of the present disclosure;

FIG. 6 is a diagram illustrating a flow control valve in FIG. 5;

FIG. 7 is a diagram illustrating an opening strategy of the flow control valve according to another exemplary embodiment of the present disclosure; and

FIG. 8 is a diagram illustrating a valve structure according to another exemplary embodiment of the present disclosure.

It should be understood that the appended drawings are not necessarily to scale, presenting a somewhat simplified representation of various exemplary features illustrative of the basic principles of the present disclosure. The specific design features of the present disclosure as included herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Advantages and features of the present disclosure and methods of achieving the same will become apparent with reference to the exemplary embodiments described below in detail However, the present disclosure is not limited to the exemplary embodiments included below, and may be implemented in various different forms. The exemplary embodiments are provided to ensure that the present disclosure of the present disclosure is complete, and to completely explain the scope of the present disclosure to those skilled in the art to which the present disclosure pertains. The present disclosure is defined only by the scope of the claims. The same reference numerals represent the same components throughout the specification.

Terms such as “part”, “unit”, and “module” described in the specification mean a unit configured to process at least one function or operation, and the unit may be implemented by hardware or software or a combination of hardware and software.

Meanwhile, in the present specification, terms such as “first” and “second” are used to describe various components having the same names, and the terms are used only for distinguishing one component from other components. The components are not limited by the terms in the following description.

The detailed description is illustrative of the present disclosure. Furthermore, the above description indicates exemplary embodiments of the present disclosure. The present disclosure may be used in various other combinations, modifications, and environments. That is, the present disclosure is directed to cover not only the embodiments, but also various alternatives, modifications, equivalents, and other embodiments which may be included within the spirit and scope of the present disclosure as defined by the appended claims and/or within the scope of skill or knowledge in the art. The exemplary embodiments herein describe the best mode to implement the technical idea of the present disclosure, and various modifications required in specific application fields and utilizes of the present disclosure are also possible. Therefore, it will be understood that the present description is not intended to limit the present disclosure to the disclosed exemplary embodiments of the present disclosure. Additionally, the appended claims should be construed as including other embodiments as well.

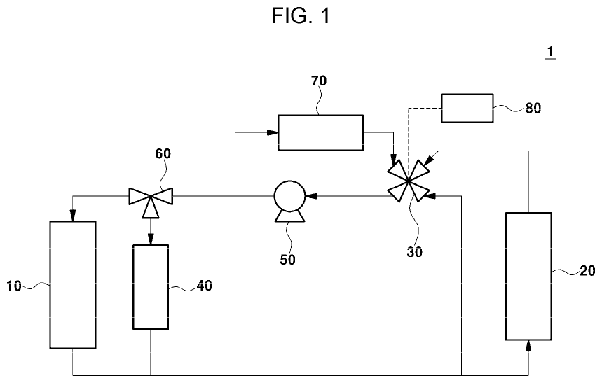

FIG. 1 is a diagram illustrating a fuel cell thermal management system according to an exemplary embodiment of the present disclosure.

Referring to FIG. 1, a fuel cell thermal management system 1 may include a fuel cell stack 10, a radiator 20, a flow control valve 30, a COD heater 40, a coolant pump 50, a bypass valve 60, an ion filter 70, and a controller 80. The fuel cell thermal management system 1 is a system configured to remove reaction heat of the fuel cell stack 10 to the outside of the system using a coolant, to control the operating temperature of the fuel cell stack 10, and to perform a water management function.

The fuel cell stack 10 may receive air and hydrogen to generate electric power through a chemical reaction. A coolant may be introduced into the fuel cell stack 10 to release heat, which is a by-product generated by the chemical reaction of the fuel cell stack 10.

The radiator 20 may re-cool the coolant, the temperature of which is raised by the chemical reaction of the fuel cell stack 10. The cooled coolant may flow to the flow control valve 30.

The flow control valve 30 may be configured for controlling opening and closing of the valve according to the control mode of the fuel cell thermal management system 1. The flow control valve 30 may be a four-way valve. A coolant may flow from the fuel cell stack 10, the radiator 20, and the ion filter 70 toward the flow control valve 30, and a coolant may flow from the flow control valve 30 toward the coolant pump 50. The flow rate and the flow direction of the coolant may be controlled by the controller 20 according to the opening and closing of the flow control valve 30.

The COD heater 40 may consume power generated in the fuel cell stack 10 to raise the temperature of a coolant when it is necessary to raise the temperature of the coolant or to lower the voltage of the fuel cell stack 10. When regenerative braking is continuously performed when the fuel cell system is ON or OFF and when the SOC value of a high-voltage battery is sufficient, the COD heater 40 may be operated to consume power generated in the fuel cell stack 10.

The coolant pump 50 may supply a coolant transferred from the flow control valve 30 to the bypass valve 60 and/or the ion filter 70.

The bypass valve 60 may supply the coolant supplied from the coolant pump 50 to at least one of the fuel cell stack 10 or the COD heater 40. The bypass valve 60 may be a three-way valve.

The ion filter 70 may remove ions contained in a coolant. The ion filter 70 may remove ions contained in a coolant provided by the coolant pump 50, and the coolant from which the ions are removed may flow into the flow control valve 30.

The controller 80 may be configured for controlling the operation of the fuel cell thermal management system 1 including the radiator 20, the flow control valve 30, the coolant pump 50, and the bypass valve 60. The controller 80 may be configured for controlling the degree of cooling a coolant by controlling a cooling fan forming the radiator 20. The controller 80 may be configured for controlling the flow rate of a coolant and the flow path of a coolant by controlling the opening angle of the flow control valve 30 and the bypass valve 60. The controller 80 may be configured for controlling the supply pressure of a coolant and the speed thereof by controlling the revolutions per minute (RPM) of the coolant pump 50.

The controller 80 may be configured for controlling the opening angle of the flow control valve 30 according to a control mode of the fuel cell thermal management system 1. For example, the control mode is associated with driving of a vehicle including the fuel cell thermal management system 1 mounted therein, and the same may include a temperature control mode and a high power mode. The temperature control mode may mean a mode configured to cool a coolant, the temperature of which is raised by heat generated in the fuel cell stack 10, when a vehicle operates normally. Therefore, in the temperature control mode, a coolant may flow into the fuel cell stack 10 and the radiator 20, or a coolant may flow from the fuel cell stack 10 and the radiator 20 to the flow control valve 30. However, when a vehicle is traveling at a low speed (i.e., a speed lower than a predetermined speed), a coolant may not flow from the radiator 20 to the flow control valve 30 in the temperature control mode. The high power mode may mean a mode configured to maximally cool a coolant, the temperature of which is raised by heat generated in the fuel cell stack 10, when a vehicle is driven with high power.

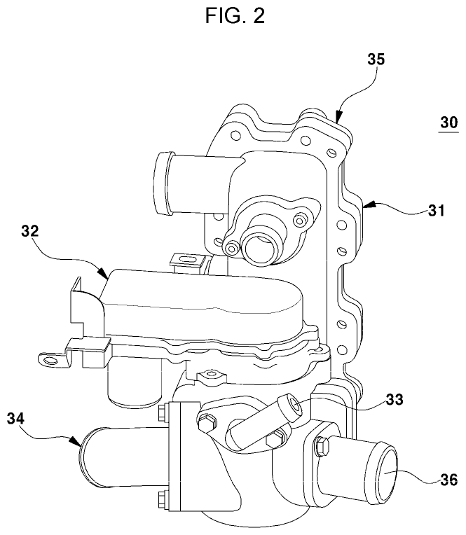

FIG. 2 is a diagram illustrating the flow control valve in FIG. 1.

Referring to FIG. 1 and FIG. 2, the flow control valve 30 may include a housing 31, an actuator 32, and a valve structure. The valve structure may be disposed inside the housing 31.

The housing 31 may include a first port 33 connected to the ion filter 70, a second port 34 connected to the radiator 20, a third port 35 connected to the fuel cell stack 10, and a fourth port 36 connected to the coolant pump 50. The opening amounts of the first port 33, the second port 34, the third port 35, and the fourth port 36 may be adjusted by rotation of the valve structure in accordance with a control signal of the controller 80. The valve structure may be rotated by the actuator 32.

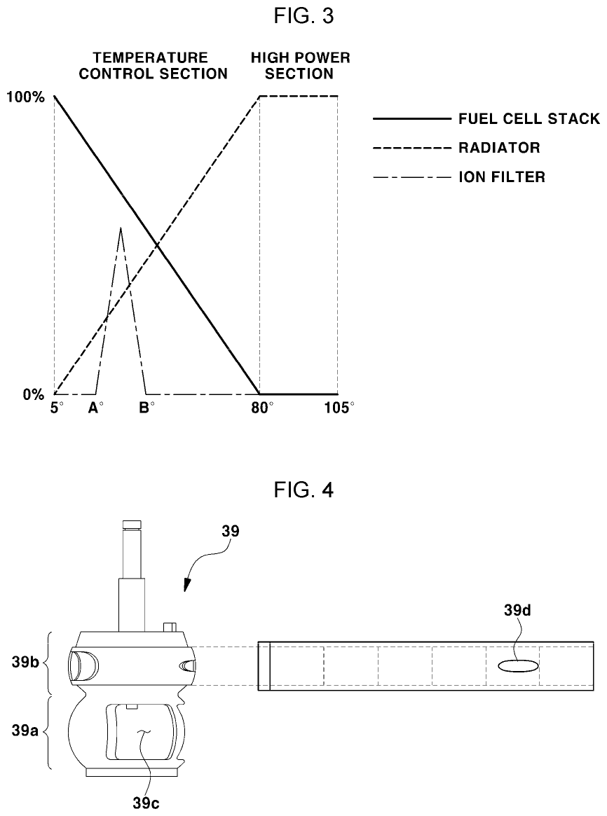

FIG. 3 is a diagram illustrating an opening strategy of the flow control valve according to the exemplary embodiment of the present disclosure.

Referring to FIG. 1, FIG. 2, and FIG. 3, the opening angle of the flow control valve 30 may be controlled according to the control mode of the fuel cell thermal management system 1. A temperature control section may mean a section in which the flow rate of a coolant flowing into each port of the flow control valve 30 from the fuel cell stack 10, the radiator 20, and the ion filter 70 in the temperature control mode of the control mode is expressed as a percentage. A high power section may mean a section in which the flow rate of a coolant flowing into each port of the flow control valve 30 from the fuel cell stack 10, the radiator 20, and the ion filter 70 in the high power mode of the control mode is expressed as a percentage. During a cold start mode configured to prevent a coolant from flowing into the fuel cell stack 10, the flow control valve 30 may be controlled at a preset angle. For example, the angle of the flow control valve 30 may be fixed at five degrees during the cold start mode of the fuel cell stack 10. However, the specific angle of five degrees may be a value which may be changed by a designer.

The temperature control section may mean a section between a point at which the port connected to the radiator 20 is completely closed and the port connected to the fuel cell stack 10 is completely opened and a point at which the port connected to the radiator 20 is completely opened and the port connected to the fuel cell stack 10 is completely closed. In other words, the temperature control section may mean a section between a point at which the second port 34 is completely closed and the third port 35 is completely opened and a point at which the second port 34 is gradually opened and completely opened and the third port 35 is gradually closed and completely closed. For example, the temperature control section may mean a section between 5 degrees and 80 degrees.

In the temperature control section, as the opening angle of the flow control valve 30 increases, the opening amount of the second port 34 connected to the radiator 20 may increase. Furthermore, in the temperature control section, as the opening angle of the flow control valve 30 increases, the closing amount of the third port 35 of the flow control valve 30 connected to the fuel cell stack 10 may increase. In the temperature control section, a portion of the first port 33 of the flow control valve 30 connected to the ion filter 70 may be opened only within a specific section. In other words, the controller 80 may control, in the temperature control section, the flow control valve 30 so that the first port 33 of the flow control valve 30 connected to the ion filter 70 is opened only within a specific section. The specific section may mean a section in which the opening angle of the flow control valve 30 is A degrees to B degrees in FIG. 3.

For example, the first port 33 may be partially opened within the opening angle range of the flow control valve 30 in which the opening amount of the third port 35 is greater than the opening amount of the second port 34. In other words, in a section where the opening amount of the second port 34 connected to the radiator 20 is greater than the opening amount of the third port 35 connected to the fuel cell stack 10, the first port 33 connected to the ion filter 70 may be opened. That is, in a section where the opening amount of the second port 34 connected to the radiator 20 is smaller than the opening amount of the third port 35 connected to the fuel cell stack 10, the first port 33 connected to the ion filter 70 may not be opened. The flow rate of a coolant flowing into the flow control valve 30 by opening the first port 33 of the flow control valve 30 connected to the ion filter 70 may be less than 50% of the maximum flow rate of a coolant flowing from the radiator 20 into the flow control valve 30. In the temperature control section, the opening section and the opening amount of the first port 33 connected to the ion filter 70 are controlled, making it possible not only to minimize the flow rate of a coolant flowing into the ion filter 70 but also to improve durability of the ion filter 70.

In the high power section, all the high-temperature coolants discharged from the fuel cell stack 10 may flow into the radiator 20. Because maximum cooling of a coolant is performed in the high power section, the coolant may not flow into the flow control valve 30. Accordingly, the third port 35 of the flow control valve 30 may be closed.

According to the exemplary embodiment of the present disclosure, durability of the ion filter 70 may be improved by controlling, in the temperature control section of the fuel cell thermal management system 1, the flow rate of a coolant flowing into the ion filter 70 and whether the coolant flows into the ion filter 70.

When the first port 33 of the flow control valve 30 connected to the ion filter 70 is continuously opened in the temperature control section, durability of the ion filter 70 may deteriorate, and when the first port 33 is continuously closed, conductivity of a coolant may increase. Therefore, according to the exemplary embodiment of the present disclosure, the first port 33 of the flow control valve 30 connected to the ion filter 70 is partially opened only in a specific section in the temperature control section, solving problems such as deterioration in durability of the ion filter 70 and an increase in conductivity of a coolant.

FIG. 4 is a diagram illustrating a valve structure according to the exemplary embodiment of the present disclosure.

Referring to FIG. 1, FIG. 2, FIG. 3, and FIG. 4, a valve structure 39 may be disposed in the housing 31 and rotated by the actuator 32. The valve structure 39 may fluidically-communicate with some of the ports 33, 34, 35, and 36 formed on the housing 31. The valve structure 39 may be formed of a plurality of stages. The valve structure 39 may include a plurality of openings 39c and 39d configured to fluidically-communicate with the first port 33, the second port 34, the third port 35, and the fourth port 36. The plurality of openings 39c and 39d may mean a space opened to allow a coolant to flow into the flow control valve 30 and to allow a coolant to be discharged from the flow control valve 30 to the coolant pump 50. The plurality of openings 39c and 39d may include a main opening 39c and a first opening 39d.

For example, a first stage 39a of the valve structure 39 may fluidically-communicate with the second port 34, the third port 35, and the fourth port 36, and a second stage 39b of the valve structure 39 may fluidically-communicate with the first port 33.

Accordingly, the main opening 39c provided in the first stage 39a may fluidically-communicate with the second port 34, the third port 35, and the fourth port 36. Rotation of the valve structure 39 may allow the main opening 39c to fluidically-communicate with each of the second port 34, the third port 35, and the fourth port 36.

The first opening 39d may fluidically-communicate with the first port 33. When the first port 33 and the first opening 39d are completely engaged with each other, only a portion of the first port 33 may be opened. In other words, when the first opening 39d is opened, the opening area of the first opening 39d may not be sufficient to completely open the first port 33.

For example, in the temperature control section, the first port 33 of the flow control valve 30 connected to the ion filter 70 may fluidically-communicate with the first opening 39d. The opening angle of the flow control valve 30 at which the first port 33 fluidically-communicates with the first opening 39d may be within the range of A degrees to B degrees. When the first opening 39d is opened, the opening area of the first opening 39d may not be sufficient to completely open the first port 33.

According to the exemplary embodiment of the present disclosure, in the temperature control section, the flow rate of a coolant flowing into the ion filter 70 may be limited by the valve structure 39 including the first opening 39d that does not completely open the first port 33 connected to the ion filter 70.

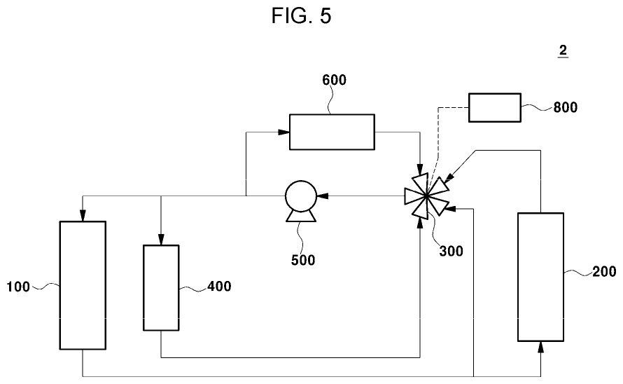

FIG. 5 is a diagram illustrating a fuel cell thermal management system according to another exemplary embodiment of the present disclosure.

Referring to FIG. 5, a fuel cell thermal management system 2 may include a fuel cell stack 100, a radiator 200, a flow control valve 300, a COD heater 400, a coolant pump 500, an ion filter 600, and a controller 800.

The fuel cell stack 100 may receive air and hydrogen to generate electric power through a chemical reaction. A coolant may be introduced into the fuel cell stack 100 to release heat, which is a by-product generated by the chemical reaction of the fuel cell stack 100.

The radiator 200 may re-cool the coolant, the temperature of which is raised by the chemical reaction of the fuel cell stack 100. The cooled coolant may flow to the flow control valve 300.

The flow control valve 300 may be configured for controlling opening and closing of the valve according to the control mode of the fuel cell thermal management system 2. The flow control valve 300 may be a five-way valve. A coolant may flow from the fuel cell stack 100, the radiator 200, the COD heater 400, and the ion filter 600 toward the flow control valve 300, and a coolant may flow from the flow control valve 300 toward the coolant pump 500. The flow rate and the flow direction of the coolant may be controlled according to the opening and closing of the flow control valve 300.

The COD heater 400 may consume power generated in the fuel cell stack 100 to raise the temperature of a coolant when it is necessary to raise the temperature of the coolant or to lower the voltage of the fuel cell stack 100.

The coolant pump 500 may supply a coolant transferred from the flow control valve 300 to the fuel cell stack 100, the COD heater 400, and/or the ion filter 600.

The ion filter 600 may remove ions contained in a coolant. The ion filter 600 may remove ions contained in a coolant provided by the coolant pump 500, and the coolant from which the ions are removed may flow into the flow control valve 300.

The controller 800 may be configured for controlling the operation of the fuel cell thermal management system 2 including the radiator 200, the flow control valve 300, and the coolant pump 500. The controller 800 may be configured for controlling the degree of cooling a coolant by controlling a cooling fan forming the radiator 200. The controller 800 may be configured for controlling the flow rate of a coolant and the flow path of a coolant by controlling the opening angle of the flow control valve 300. The controller 800 may be configured for controlling the supply pressure of a coolant and the speed thereof by controlling the revolutions per minute (RPM) of the coolant pump 500.

The controller 800 may be configured for controlling the opening angle of the flow control valve 300 according to a control mode of the fuel cell thermal management system 2. For example, the control mode is associated with driving of a vehicle including the fuel cell thermal management system 2 mounted therein, and the same may include a cold start mode and a temperature control mode. The cold start mode may mean a mode in which, when a vehicle is turned on at a low outside temperature, the temperature of the fuel cell stack 100 is raised by itself by blocking a coolant supplied to the fuel cell stack 100 and powering the fuel cell stack 100. In the temperature control mode, a coolant may flow into the fuel cell stack 100 and the radiator 200, and a coolant may flow from the fuel cell stack 100 and the radiator 200 to the flow control valve 300.

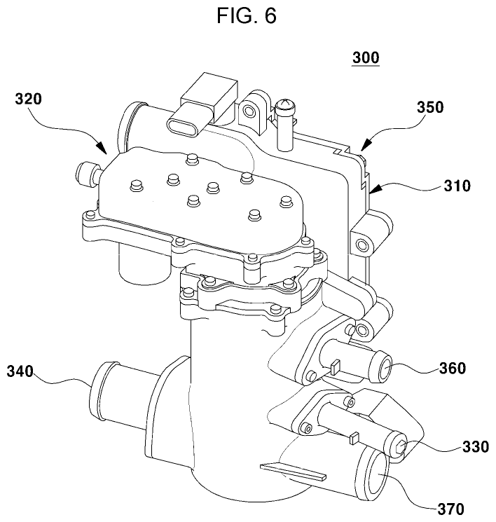

FIG. 6 is a diagram illustrating the flow control valve in FIG. 5.

Referring to FIG. 5 and FIG. 6, the flow control valve 300 may include a housing 310, an actuator 320, and a valve structure. The valve structure may be disposed inside the housing 310.

The housing 310 may include a first port 330 connected to the ion filter 600, a second port 340 connected to the radiator 200, a third port 350 connected to the fuel cell stack 100, a fourth port 360 connected to the COD heater 400, and a fifth port 370 connected to the coolant pump 500. The opening amounts of the first port 330, the second port 340, the third port 350, the fourth port 360, and the fifth port 370 may be adjusted by rotation of the valve structure. The valve structure may be rotated by the actuator 320.

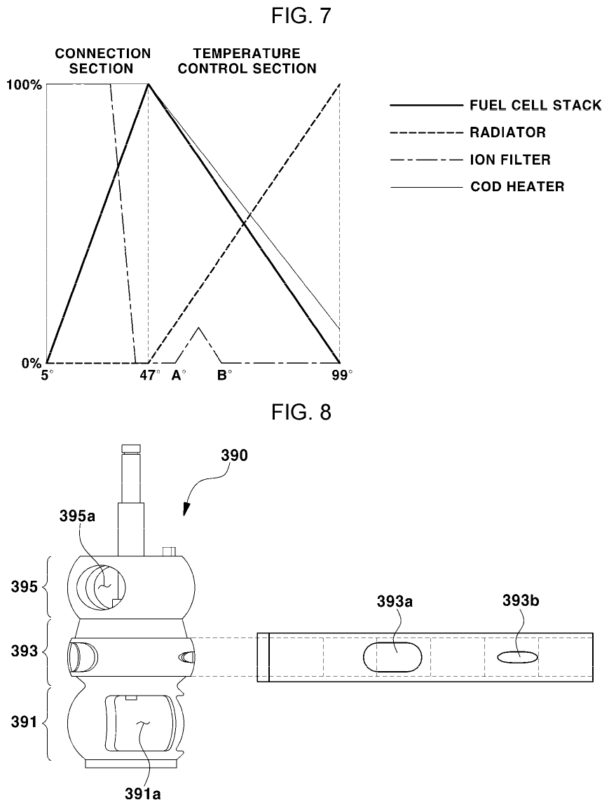

FIG. 7 is a diagram illustrating an opening strategy of the flow control valve according to another exemplary embodiment of the present disclosure.

Referring to FIG. 5, FIG. 6 and FIG. 7, the opening angle of the flow control valve 300 may be controlled according to the control modes of the fuel cell thermal management system 2. The control modes of the fuel cell thermal management system 2 may respectively correspond to a connection section and a temperature control section. In the cold start mode of the fuel cell thermal management system 2, the angle of the flow control valve 300 may be fixed at a specific angle. For example, the angle of the flow control valve 300 may be fixed at five degrees in the cold start mode. In the instant case, the second port 340 and the third port 350 of the flow control valve 300 may be closed. Therefore, it is possible to prevent a coolant from flowing into the fuel cell stack 100 in the cold start mode. However, in the cold start mode as well, the first port 330 of the flow control valve 300 may be opened.

The connection section may mean a section required to convert the angle of the flow control valve 300 in the cold start mode to an angle for the temperature control section. That is, through the connection section, the angle of the flow control valve 300 may be changed from a specific angle for cold start to an angle at which the second port 340 connected to the radiator 200 is opened. As the opening angle of the flow control valve 300 increases, the third port 350 connected to the fuel cell stack 100 may be gradually opened. At a boundary between the connection section and the temperature control section, the third port 350 connected to the fuel cell stack 100 may be completely opened, and the second port 340 connected to the radiator 200 may be completely closed.

The temperature control section may mean a section between a point at which the port connected to the radiator 200 is completely closed and the port connected to the fuel cell stack 100 is completely opened and a point at which the port connected to the radiator 200 is completely opened and the port connected to the fuel cell stack 100 is completely closed. In other words, the temperature control section may mean a section between a point at which the second port 340 is completely closed and the third port 350 is completely opened and a point at which the second port 340 is gradually opened and completely opened and the third port 350 is gradually closed and completely closed. For example, the temperature control section may mean a section between 47 degrees to 99 degrees in FIG. 7.

In the temperature control section, as the opening angle of the flow control valve 300 increases, the opening amount of the second port 34 connected to the radiator 200 may increase. Furthermore, in the temperature control section, as the opening angle of the flow control valve 300 increases, the closing amount of the third port 350 of the flow control valve 300 connected to the fuel cell stack 100 may increase. In the temperature control section, a portion of the first port 330 of the flow control valve 300 connected to the ion filter 600 may be opened only within a specific section. In other words, the controller 800 may control, in the temperature control section, the flow control valve 300 so that the first port 330 of the flow control valve 300 connected to the ion filter 600 is opened only within a specific section. The specific section may mean a section in which the opening angle of the flow control valve 300 is A degrees to B degrees in FIG. 7.

For example, the first port 330 may be partially opened within the opening angle range of the flow control valve 300 in which the opening amount of the third port 350 is greater than the opening amount of the second port 340. In other words, in a section where the opening amount of the second port 340 connected to the radiator 200 is greater than the opening amount of the third port 350 connected to the fuel cell stack 100, the first port 330 connected to the ion filter 600 may not be opened. That is, in a section where the opening amount of the second port 340 connected to the radiator 200 is smaller than the opening amount of the third port 350 connected to the fuel cell stack 100, the first port 330 connected to the ion filter 600 may be opened. The flow rate of a coolant flowing into the flow control valve 300 by opening the first port 330 of the flow control valve 300 connected to the ion filter 600 may be less than 50% of the maximum flow rate of a coolant flowing from the radiator 200 into the flow control valve 300. In the temperature control section, the opening section and the opening amount of the first port 330 connected to the ion filter 600 are controlled, making it possible not only to minimize the flow rate of a coolant flowing into the ion filter 600 but also to improve durability of the ion filter 600.

According to the exemplary embodiment of the present disclosure, the port of the flow control valve 300 connected to the ion filter 600 is partially opened in the temperature control section of the fuel cell thermal management system 2, making it possible to limit the flow rate of a coolant flowing into the ion filter 600. Accordingly, durability of the ion filter 600 may be improved.

FIG. 8 is a diagram illustrating a valve structure according to another exemplary embodiment of the present disclosure.

Referring to FIGS. 5 to 8, a valve structure 390 may be disposed in the housing 310 and rotated by the actuator 320. The valve structure 390 may fluidically-communicate with some of the ports 330, 340, 350, 360, and 370 provided in the housing 310. The valve structure 390 may be formed of a plurality of stages. The valve structure 390 may include a plurality of openings 391a, 393a, 393b, and 395a configured to fluidically-communicate with the first port 330, the second port 340, the third port 350, the fourth port 360, and the fifth port 370. The plurality of openings 391a, 393a, 393b, and 395a may mean a space opened to allow a coolant to flow into the flow control valve 300 and to allow a coolant to be discharged from the flow control valve 300 to the coolant pump 500. The plurality of openings 391a, 393a, 393b, and 395a may include a main opening 391a, a first opening 393a, a second opening 393b, and a third opening 395a. The main opening 391a and the third opening 395a may be provided in plurality.

For example, a first stage 391 of the valve structure 390 may fluidically-communicate with the second port 340, the third port 350, and the fifth port 370, a second stage 393 of the valve structure 390 may fluidically-communicate with the first port 330, and a third stage 395 of the valve structure 390 may fluidically-communicate with the third port 350 and the fourth port 360.

The main opening 391a may fluidically-communicate with the second port 340, the third port 350, and the fifth port 370. Rotation of the valve structure 390 may allow the main opening 391a to fluidically-communicate with each of the second port 340, the third port 350, and the fifth port 370.

The first opening 393a and the second opening 393b may fluidically-communicate with the first port 330. The first opening 393a and the second opening 393b may be spaced from each other. The first opening 393a and the second opening 393b may be opened with different areas. For example, the opening area of the first opening 393a may be greater than that of the second opening 393b. As the opening angle of the flow control valve 300 increases, the opening communicating with the first port 330 may change from the first opening 393a to the second opening 393b.

For example, in the connection section, the first port 330 of the flow control valve 300 connected to the ion filter 600 may fluidically-communicate with the first opening 393a. The first opening 393a may be opened with an area large enough to completely open the first port 330. Accordingly, in the connection section, the first port 330 of the flow control valve 300 connected to the ion filter 600 may not fluidically-communicate with the second opening 393b.

For example, in the temperature control section, the first port 330 of the flow control valve 300 connected to the ion filter 600 may fluidically-communicate with the second opening 393b. The opening angle of the flow control valve 300 at which the first port 330 fluidically-communicates with the second opening 393b may be within the range of A degrees to B degrees. The second opening 393b may be opened with an area which is not large enough to completely open the first port 330. Accordingly, in the temperature control section, the first port 330 of the flow control valve 300 connected to the ion filter 600 may not fluidically-communicate with the first opening 393a.

According to the exemplary embodiment of the present disclosure, a coolant may flow into the ion filter 600 in the temperature control section as well by the valve structure 390 including the openings 393a and 393b respectively opened with different opening areas, and the flow rate of the coolant flowing into the ion filter 600 may be limited in the temperature control section.

As is apparent from the above description, according to the exemplary embodiment of the present disclosure, durability of an ion filter may be improved by controlling the flow rate of a coolant flowing into the ion filter and whether the coolant flows into the ion filter in a temperature control section of a fuel cell thermal management system.

Furthermore, according to the exemplary embodiment of the present disclosure, a port of a flow control valve connected to the ion filter is partially opened only in a specific section in the temperature control section, solving problems such as deterioration in durability of the ion filter and an increase in conductivity of a coolant.

Additionally, according to the exemplary embodiment of the present disclosure, a coolant may flow into the ion filter in the temperature control section as well by a valve structure including openings respectively opened with different opening areas, and the flow rate of the coolant flowing into the ion filter may be limited in the temperature control section.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured to process data according to a program provided from the memory, and may be configured to generate a control signal according to the processing result.

The control device may be at least one microprocessor operated by a predetermined program which may include a series of commands for carrying out the method disclosed in the aforementioned various exemplary embodiments of the present disclosure.

In various exemplary embodiments of the present disclosure, each operation described above may be performed by a control device, and the control device may be configured by a plurality of control devices, or an integrated single control device.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

A singular expression includes a plural expression unless the context clearly indicates otherwise.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A control system for a flow control valve, the control system comprising:
the flow control valve configured to control a flow path of a coolant; and
a controller configured to control an opening amount of the flow control valve,
wherein the flow control valve includes ports fluidically-communicating with a fuel cell stack, a radiator, a coolant pump, and an ion filter, respectively,
wherein the ports include a first port, a second port and a third port, and the controller is configured to control the flow control valve so that the first port of the flow control valve, the first port being connected to the ion filter, is opened by the controller only within a predetermined section in a temperature control section of a fuel cell thermal management system, and
wherein the temperature control section is a section between a point at which the second port connected to the radiator is completely closed and the third port connected to the fuel cell stack is completely opened and a point at which the second port connected to the radiator is completely opened and the third port connected to the fuel cell stack is completely closed.

2. The control system of claim 1, wherein an opening amount of the second port of the flow control valve, the second port being connected to the radiator, increases as an opening angle of the flow control valve increases in the temperature control section.

3. The control system of claim 2, wherein a closing amount of the third port of the flow control valve, the third port being connected to the fuel cell stack, increases as the opening angle of the flow control valve increases in the temperature control section.

4. The control system of claim 3, wherein the first port is partially opened by the controller within an opening angle range of the flow control valve in which an opening amount of the third port is greater than the opening amount of the second port.

5. The control system of claim 1, wherein the first port of the flow control valve connected to the ion filter is partially opened by the controller in the temperature control section.

6. The control system of claim 5, wherein, in the temperature control section, a flow rate of the coolant flowing into the flow control valve by opening the first port of the flow control valve connected to the ion filter is less than 50% of a maximum flow rate of the coolant flowing from the radiator into the flow control valve.

7. The control system of claim 1,
wherein the flow control valve is a four-way valve, and
wherein the ports further include a fourth port connected to the coolant pump.

8. The control system of claim 7, further including a bypass valve including a first port connected to the fuel cell stack, a second port connected to the COD heater and a third port connected to the ion filter and the coolant pump.

9. The control system of claim 1,
wherein the flow control valve is a five-way valve, and
wherein the ports further include a fourth port connected to the coolant pump and a fifth port connected to a COD heater.

10. The control system of claim 9, wherein the coolant pump is connected to the ion filter, the fuel cell stack and the COD heater in parallel.

11. The control system of claim 1,
wherein the flow control valve includes:
a housing including the first port, the second port, the third port and a fourth port fluidically-communicating with the fuel cell stack, the radiator, the coolant pump, and the ion filter, respectively; and
a valve structure disposed in the housing and rotated to fluidically-communicate with a portion of the ports, and
wherein the valve structure is formed of a plurality of stages.

12. The control system of claim 11,
wherein the stages of the valve structure includes one stage configured to fluidically-communicate with the ion filter, and
wherein the one stage includes, when the flow control valve is the five-way valve, a first opening and a second opening opened for a flow of the coolant.

13. The control system of claim 12,
wherein the first opening and the second opening are spaced from each other, and
wherein an opening area of the first opening is greater than an opening area of the second opening.

14. The control system of claim 12, wherein the first port of the flow control valve connected to the ion filter is configured to fluidically-communicate with the second opening in the temperature control section.

15. The control system of claim 11, wherein the stages of the valve structure includes:
a first stage configured to fluidically-communicate with the radiator and the coolant pump;
a second stage configured to fluidically-communicate with the ion filter; and
a third stage configured to fluidically-communicate with the fuel cell stack and a COD heater.

16. The control system of claim 11,
wherein the valve structure includes one stage configured to fluidically-communicate with the ion filter, and
wherein the one stage includes, when the flow control valve is the four-way valve, one opening opened for a flow of the coolant.

17. The control system of claim 16,
wherein the first port of the flow control valve connected to the ion filter is configured to fluidically-communicate with the one opening in the temperature control section, and
wherein the first port is partially opened by the one opening.

18. The control system of claim 16, wherein the stages of the valve structure includes:
a first stage configured to fluidically-communicate with the radiator and the coolant pump; and
a second stage configured to fluidically-communicate with the ion filter.
